(19) United States
(12) Patent Application Publication
(10) Pub. No.: US 2013/0319709 A1
(43) Pub. Date: Dec. 5, 2013

(54) HAMMER MECHANISM

(71) Applicants: Joachim Hecht, Magstadt (DE); Martin Kraus, Filderstadt (DE)

(72) Inventors: Joachim Hecht, Magstadt (DE); Martin Kraus, Filderstadt (DE)

(73) Assignee: Robert Bosch GMBH, Stuttgart (DE)

(21) Appl. No.: 13/990,307

(22) PCT Filed: Oct. 14, 2011
(86) PCT No.: PCT/EP11/67968

§ 371 Date: Aug. 8, 2013

(30) Foreign Application Priority Data
Nov. 29, 2010 (DE) 10 2010 062 094.7

(51) Int. Cl. B25D 16/00

(52) U.S. Cl. CPC B25D 16/00
USPC 173/109

(57) ABSTRACT

A hammer mechanism having at least one impact-generation unit and a clamping chuck drive shaft is provided. The impact-generation unit includes a spur-gear transmission stage for translating a rotational speed of the clamping chuck drive shaft into a higher rotational speed for impact generation.

### BACKGROUND INFORMATION

Handheld machine tools having an impact-generation unit, in which a hammer is supported inside a hammer cylinder so as to be able to move, are already known. An intermediate shaft drives an impact-generation unit, and the hammer cylinder is driven at a lower rotational speed via a spur-gear transmission stage.

### SUMMARY

A hammer mechanism is provided, which has at least one impact-generation unit and a clamping chuck drive shaft, the impact-generation unit having a spur-gear transmission stage for translating a rotational speed of the clamping chuck drive shaft into a higher rotational speed to produce the strikes. An “impact-generation unit” specifically denotes a unit provided to translate a rotary motion into an in particular translatory strike motion of a hammer means of the hammer mechanism, which is suitable for drilling or impact drilling. In particular, the impact-generation unit is developed as an impact-generation unit that is considered useful by the expert, but preferably as a pneumatic impact-generation unit and/or especially preferably, as an impact-generation unit having a rocker lever. A “rocker lever” in particular denotes a means which is supported so as to allow movement about a pivot axis and which is provided to output power, picked up in a first coupling area, to a second coupling area. A “clamping chuck drive shaft” in particular denotes a shaft which transmits a rotary motion from a gearing, especially a planetary gearing, in the direction of a clamping chuck in a drilling and/or impact drilling operation. Preferably, the clamping chuck drive shaft is at least partially developed as full shaft. The clamping chuck drive shaft preferably extends across at least 40 mm in the strike direction. In a drilling and/or impact drilling operation, the clamping chuck drive shaft and the clamping chuck preferably always have the same rotational speed, i.e., no gear unit is provided on a drive train between the clamping chuck drive shaft and the clamping chuck. A “strike direction” in particular denotes a direction which extends parallel to an axis of rotation of the clamping chuck and is directed from the hammer mechanism in the direction of the clamping chuck. Preferably, the strike direction is aligned parallel to an axis of rotation of the clamping chuck drive shaft. A “spur-gear transmission stage” in particular denotes a system of especially two toothed wheel works engaging with one another, which are supported so as to be rotatable about parallel axes. On a surface facing away from their axis, the toothed wheel works preferably have gear teeth. “Provided” in particular is to be understood as specially designed and/or equipped. A “rotational speed for impact generation” is a rotational speed of a drive means of the impact-generation unit that is considered useful by the expert, which translates a rotary motion into a linear motion. Preferably, the drive means of the impact-generation unit is developed as wobble bearing or, especially preferably, as an eccentric element. “Translate” in this case means that there is a difference in the rotational speed of the clamping chuck drive shaft and the rotational speed for the impact generation. Preferably, the rotational speed for an impact generation is higher, advantageously at least twice as high as the rotational speed of the clamping chuck drive shaft. Especially preferably, a translation ratio between the rotational speed for impact generation and the rotational speed of the clamping chuck drive shaft is a non-integer ratio. Because of the development of the hammer mechanism according to the present invention, an especially advantageous ratio between the rotational speed and the number of impacts of an inserted tool is able to be achieved in a space-saving and constructionally simple manner.

In another development, the impact-generation unit has a hammer mechanism shaft whose axis of rotation is disposed next to the clamping chuck drive shaft in the radial direction, which makes for an especially effective and low-vibration strike generation. Using simple design measures, in particular, an especially advantageous lever effect of the rocker lever is achievable. A “hammer mechanism shaft” in particular denotes a shaft which mounts at least a portion of the drive means of the impact-generation unit in a manner allowing a rotation about an axis. In an impact drilling operation, the hammer mechanism shaft preferably outputs power only to the drive means, which power is acting at least partially on a workpiece. In particular, the hammer mechanism shaft outputs no power to the clamping chuck that drives the clamping chuck in rotational manner. The term “disposed next to the clamping chuck drive shaft in the radial direction” in particular means that the clamping chuck drive shaft and the hammer mechanism shaft are mounted so as to be rotatable about two axes of rotation disposed parallel to each other, in particular. At least one plane aligned perpendicularly to the axes of rotation preferably intersects the clamping chuck drive shaft and the hammer mechanism shaft.

Furthermore, the impact-generation unit has at least one bearing for mounting the hammer mechanism shaft in axially fixated manner, thereby resulting in an especially minimal construction outlay. In this context a “bearing” in particular describes a means for mounting the impact-generation unit in a way that allows it to rotate about an axis of rotation in relation to a housing. In particular, the phrase “axially fixed in place” means that the bearing supports the hammer mechanism shaft relative to the housing in a direction parallel to the axis of rotation, but does not allow any movement.

In one advantageous development of the present invention, the impact-generation unit includes a hammer means which in at least one operating state is supported by the clamping chuck drive shaft so as to allow movement in the strike direction, thereby providing lower weight and a smaller size. A “hammer means” in particular denotes a means of the hammer mechanism which is meant to be accelerated by the impact-generation unit during operation, in particular in translatory fashion, and to output a pulse, picked up during the acceleration, in the form of a strike pulse in the direction of an inserted tool. Preferably, the hammer means is supported by air pressure or advantageously by a rocker lever, in a way that allows it to be accelerated in the strike direction. Directly prior to a strike, the hammer means preferably is in a non-accelerated state. During a strike, the hammer means preferably applies a strike pulse in the direction of the inserted tool, in particular via a snap die. The term “support so as to be movable” specifically means that the clamping chuck drive shaft has a bearing surface which in at least one operating state transmits bearing forces to the strike mechanism, perpendicularly to the strike direction.

Furthermore, it is provided that the clamping chuck drive shaft at least partially penetrates the hammer means, so that a clamping chuck drive shaft having an especially low mass and a small space requirement is able to be provided. The phrase “at least partially penetrate” in particular means that the hammer means encloses the clamping chuck drive shaft by more than 270 degrees, advantageously by 360 degrees on at least one plane which advantageously is oriented perpendicularly to the strike direction. Preferably, the hammer means is mounted on the clamping chuck drive shaft in form-fitting manner in a direction perpendicular to the axis of rotation of the clamping chuck drive shaft, i.e., supported in movable manner in the direction of the axis of rotation.

In addition, it is provided that the hammer mechanism includes at least one bearing for mounting the clamping chuck drive shaft in axially displaceable manner, thereby providing a hammer mechanism deactivation which is simple to produce. A “bearing” in this context describes a device which mounts the clamping chuck drive shaft in particular in relation to the housing in a manner that allows it to move at least about the axis of rotation. In particular, the phrase “axially displaceable” means that the bearing mounts the clamping chuck drive shaft in a manner that allows it to move, especially relative to the housing, parallel to the strike direction. Preferably, a connection of the coupling means of the clamping chuck drive shaft driving the impact-generation unit is reversible by axial shifting of the clamping chuck drive shaft.

It is furthermore provided that the hammer mechanism includes a planetary gearing, which drives the clamping chuck drive shaft in at least one operating state, so that an advantageous translation is able to be achieved in a space-saving manner. Moreover, a torque restriction and a plurality of gear stages are realizable by simple design measures. A “planetary gearing” in particular means a unit having at least one planetary wheel set. A planetary wheel set preferably includes a sun gear, a ring gear, a planetary wheel carrier and at least one planetary wheel which is guided by the planetary wheel carrier along a circular path about the sun gear. Preferably, the planetary gearing has at least two translation ratios, selectable by the operator, between an input and an output of the planetary gearing.

Furthermore, the hammer mechanism has a clamping chuck and a snap die provided with coupling means for transmitting a rotary motion to the clamping chuck, so that an especially compact hammer mechanism is able to be made available. The snap die advantageously transmits a rotary motion of the clamping chuck drive shaft to the clamping chuck. The term “clamping chuck” in particular describes a device for the direct mounting of the inserted tool in at least torsionally fixed manner, such that it is able to be detached by a user, in particular without employing a tool. A “snap die” in particular means an element of the hammer mechanism that transmits the strike pulse from the hammer in the direction of the inserted tool during a strike. The snap die preferably strikes the inserted tool directly in at least one operating state. The snap die preferably prevents dust from entering the hammer mechanism through the clamping chuck. “Coupling means” in particular denotes means provided to transmit a motion from one component to another component by at least a keyed connection. The keyed connection preferably allows the user to reverse the connection in at least one operating state. In an especially preferred manner, the keyed connection is reversible for switching an operating mode, i.e., advantageously between a screwing operation, a drilling operation, a cutting operation and/or an impact drilling operation. The coupling means in particular is developed as a coupling considered useful by the expert, but advantageously as a dog clutch and/or toothing. In an advantageous manner, the coupling means includes a plurality of keyed connection elements and a region that connects the keyed connection elements.

Furthermore, the hammer mechanism includes a coupling means which is connected to the clamping chuck drive shaft in torsionally fixed manner and provided to drive the impact-generation unit, thereby providing an especially compact and powerful hammer mechanism in a simple manner in terms of production. “In torsionally fixed manner” in particular means that the coupling means and the clamping chuck drive shaft are fixedly connected to each other in at least the circumferential direction, preferably in all directions, i.e., in particular in all operating states. “Drive” in this context in particular means that the coupling means transmits kinetic energy, in particular rotational energy, to at least one region of the impact-generation unit. The impact-generation unit preferably uses this energy to drive the hammer means. The development according to the present invention makes it possible to provide an especially compact and powerful hammer mechanism using constructionally simple measures.

Moreover, the hammer mechanism includes an impact-generation deactivation unit having a blocking element which in at least a drilling operation and especially in a screw-fitting operation, acts on the snap die, parallel to at least one force of the clamping chuck drive shaft, so that an advantageous placement of an operating element of the impact-generation deactivation unit is possible by constructionally simple measures. Especially an annular operating element, which encloses the snap die or the clamping chuck drive shaft, is easily able to be realized. In addition, this development requires little space. An “impact-generation deactivation unit” in particular means a unit provided to allow an operator to switch off the impact-generation unit for drilling and/or screw-fitting. Preferably, the impact-generation deactivation unit prevents an especially automatic activation of the impact-generation unit when the inserted tool is pressed against a workpiece in a drilling and/or screw-fitting mode. The pressure application in a cutting and/or impact drilling mode preferably causes an axial displacement of the clamping chuck drive shaft. In an advantageous manner, the blocking element is provided to prevent an axial displacement of the clamping chuck drive shaft, the clamping chuck and/or advantageously, the snap die in the drilling and/or screw-fitting mode. “Parallel to a force” in particular means that the clamping chuck drive shaft and the blocking element apply a force to the snap die at two different locations in at least one operating state.

As an alternative or in addition, the clamping chuck drive shaft and the blocking element are able to exert a force on the clamping chuck at two different locations in at least one operating state. The forces preferably have a component that is aligned in the same direction, i.e., preferably parallel to the axis of rotation of the clamping chuck drive shaft, from the clamping chuck drive shaft in the direction of the clamping chuck. The blocking element preferably acts directly on the snap die, but especially preferably, at least via a clamping chuck bearing. The clamping chuck drive shaft preferably acts directly on the snap die. The snap die preferably transmits a rotary motion of the clamping chuck drive shaft to the clamping chuck.

Furthermore, the hammer mechanism includes a torque-restriction device for restricting a torque that is maximally transmittable via the clamping chuck drive shaft, so that the operator is advantageously protected and the handheld tool is able to be used in a comfortable and safe manner to perform screw-fitting operations. “Restrict” in this context in particular means that an exceeding of the maximum torque adjustable by an operator, in particular, is prevented by the torque-restriction device. Preferably, the torque-restriction device opens a connection between a drive motor and the clamping chuck, which is torsionally fixed during operation. As an alternative or in addition, the torque-restriction device may act on an energy supply of the drive motor.

Moreover, a handheld tool which includes a hammer mechanism according to the present invention is provided. A “handheld tool” in this context in particular denotes a handheld tool that appears useful to an expert, but preferably a drilling machine, an impact drill, a screw driller, a boring tool and/or a percussion drill. The handheld tool preferably is developed as battery-operated handheld tool, i.e., the handheld tool in particular includes a coupling means provided to supply a drive motor of the handheld tool with electrical energy from a handheld tool battery pack connected to the coupling means.

### BRIEF DESCRIPTION OF THE DRAWINGS

FIG. 1 shows a handheld tool having a hammer mechanism according to the present invention, in a perspective view.

FIG. 2 shows a section of the hammer mechanism of FIG. 1.

FIG. 3 shows a coupling arrangement, clamping chuck drive shaft, snap die, and a portion of a clamping chuck of the hammer mechanism from FIG. 1, shown individually in a perspective view.

FIG. 4 shows another part-sectional view of the hammer mechanism from FIG. 1, which shows an impact-generation deactivation unit of the hammer mechanism.

FIG. 5 shows a first alternative exemplary embodiment of a snap die of the hammer mechanism from FIG. 1 in a schematic representation.

FIG. 6 shows a second alternative exemplary embodiment of a snap die of the hammer mechanism from FIG. 1 in a schematic representation.

FIG. 7 shows a third alternative exemplary embodiment of a snap die of the hammer mechanism from FIG. 1 in a sectional view.

FIG. 8 shows the snap die from FIG. 7 in a first perspective view.

FIG. 9 shows the snap die from FIG. 7 in a second perspective view.

FIG. 10 shows a portion of a clamping chuck of the hammer mechanism of FIG. 7 in a perspective view.

FIG. 11 shows a fourth alternative exemplary embodiment of a snap die of the hammer mechanism from FIG. 1 in a schematic representation.

### DETAILED DESCRIPTION

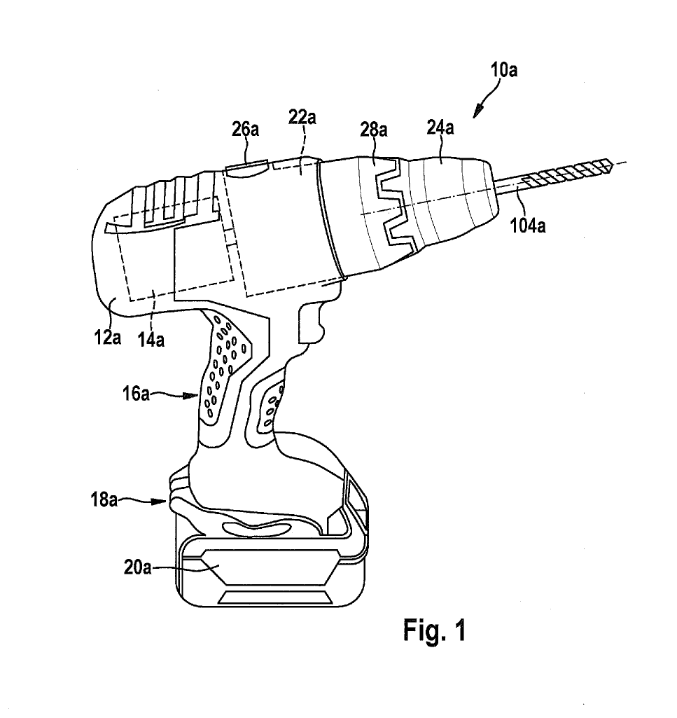

FIG. 1 shows a handheld tool 10a, which is developed as impact drill screwer. Handheld tool 10a has a pistol-shaped housing 12a. A drive motor 14a of handheld tool 10a is situated inside housing 12a. Housing 12a has a handle region 16a and a battery coupling means 18a, which is disposed at an end of handle region 16a facing away from drive motor 14a. Battery coupling means 18a links a handheld tool battery 20a in a manner that allows an operator to sever the link electrically or mechanically. Handheld tool battery 20a has an operating voltage of 10.8 Volt, but could also have a different, especially higher, operating voltage. Furthermore, handheld tool 10a has a hammer mechanism 22a according to the present invention, which includes a clamping chuck 24a disposed on the outside, and operating elements 26a, 28a.

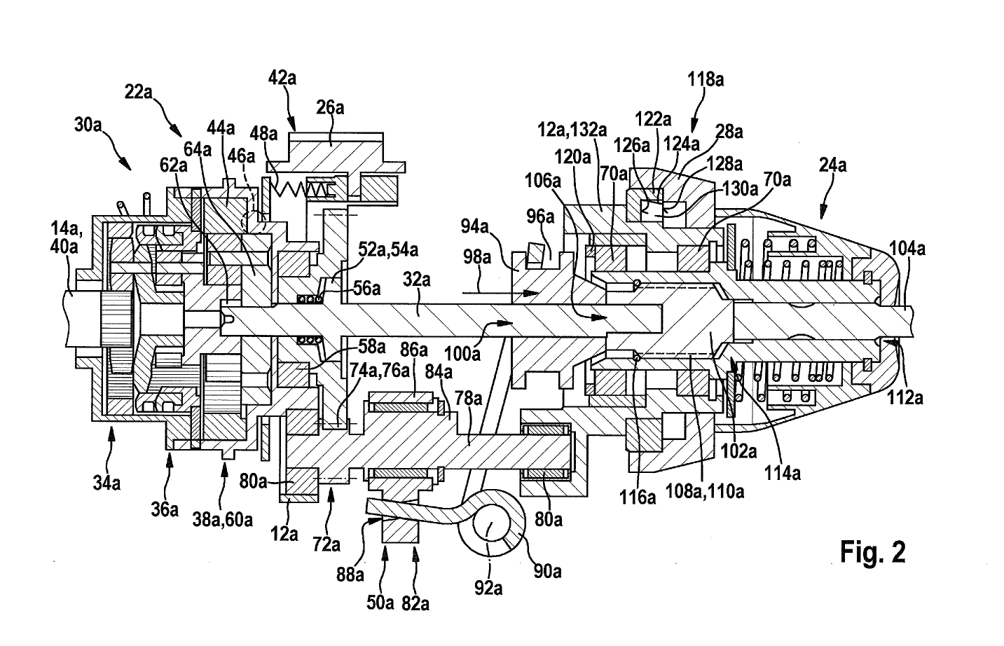

FIG. 2 shows hammer mechanism 22a in a sectional view. Hammer mechanism 22a also includes a planetary gearing 30a and a clamping chuck drive shaft 32a. When in operation, planetary gearing 30a drives clamping chuck drive shaft 32a to execute rotary motions about an axis of rotation. To do so, planetary gearing 30a has three planetary gear stages 34a, 36a, 38a. An operator is able to adjust a transmission ratio of planetary gearing 30a between a rotor 40a of drive motor 14a and clamping chuck drive shaft 32a in at least two stages. As an alternative, a transmission ratio between drive motor 14a and clamping chuck drive shaft 32a could also be designed not to be adjustable.

Hammer mechanism 22a has a torque restriction device 42a. Torque restriction device 42a keeps a ring gear 44a of planetary gearing 30a fixated during a working process. Toward this end, torque restriction device 42a includes fixation balls 46a, which engage with recesses of ring gear 44a. A spring 48a of torque restriction device 42a exerts a force on fixation balls 46a in the direction of ring gear 44a in the process. An operator is able to move an end of spring 48a facing fixation balls 46a in the direction of fixation balls 46a by means of one of operating elements 26a. Operating element 26a is provided with an eccentric element for this purpose. Thus, the force acting on fixation balls 46a is adjustable. If a particular maximum torque has been reached, fixation balls 46a are pressed out of the recesses, and ring gear 44a runs freely, so that a force transmission between rotor 40a and clamping chuck drive shaft 32a is interrupted. Torque restriction device 42a thus is provided to restrict a maximum torque transmittable via clamping chuck drive shaft 32a.

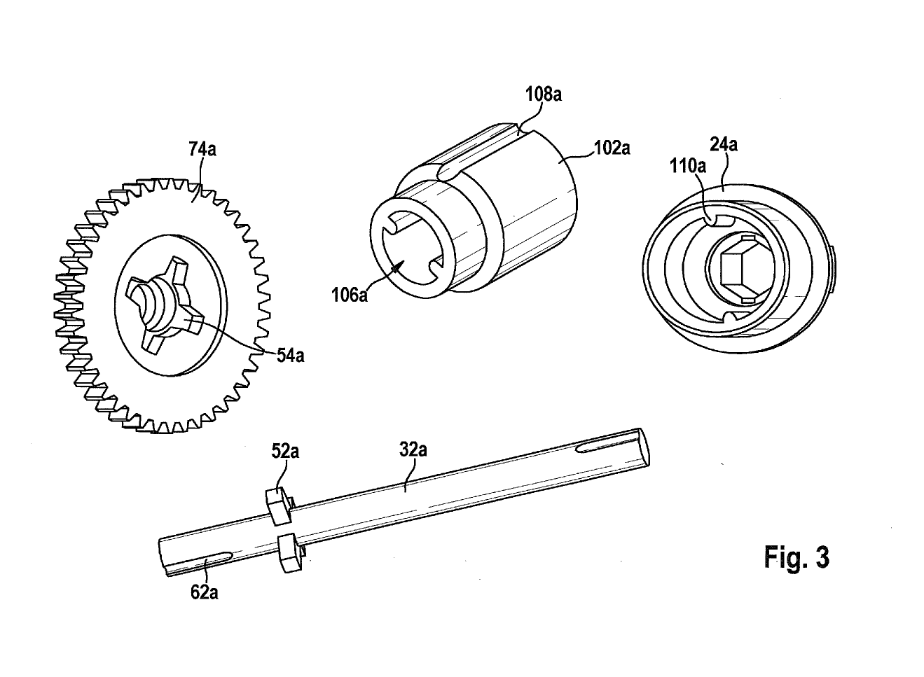

Hammer mechanism 22a has an impact-generation unit 50a and a first coupling means 52a. First coupling means 52a is connected to clamping chuck drive shaft 32a in torsionally fixed manner, first coupling means 52a and clamping chuck drive shaft 32a being formed in one piece, in particular. Impact-generation unit 50a includes a second coupling means 54a, which is connected to first coupling means 52a in torsionally fixed manner during a drilling and/or impact drilling mode. As shown in FIG. 3 as well, first coupling means 52a is developed in the form of premolded shapes and second coupling means 54a as recesses. When the drilling mode is activated, first coupling means 52a dips into second coupling means 54a, i.e., to the full extent. As a result, the coupling between first coupling means 52a and second coupling means 54a is reversible by axial shifting of clamping chuck drive shaft 32a in the direction of clamping chuck 24a. A spring 56a of hammer mechanism 22a is situated between first coupling means 52a and second coupling means 54a. Spring 56a presses clamping chuck drive shaft 32a in the direction of clamping chuck 24a. When impact-generation unit 50a is deactivated, it opens the linkage between first coupling means 52a and second coupling means 54a.

Hammer mechanism 22a has a first bearing 58a, which fixates second coupling means 54a relative to housing 12a in the axial direction and rotationally mounts it in coaxial manner with respect to clamping chuck drive shaft 32a. Furthermore, hammer mechanism 22a has a second bearing 60a, which rotationally mounts clamping chuck drive shaft 32a on a side facing drive motor 14a, such that it is able to rotate about the axis of rotation. Second bearing 60a is integrally formed with one of the three planetary gear stages. Clamping chuck drive shaft 32a includes a coupling means 62a, which connects it to a planet carrier 64a of this planetary gear stage 38a in axially displaceable and torsionally fixed manner. As a result, planetary gear stage 38a is provided to support clamping chuck drive shaft 32 in axially displaceable manner. On a side facing clamping chuck 24a, clamping chuck drive shaft 32a together with clamping chuck 24a is rotationally mounted by a clamping chuck bearing 70a. Clamping chuck bearing 70a has a rear bearing element, which is pressed onto clamping chuck 24a in axially fixated manner. In addition, clamping chuck bearing 70a has a front bearing element which supports clamping chuck 24a inside housing 12a in axially displaceable manner.

Impact-generation unit 50a includes a spur-gear transmission stage 72a, which translates a rotational speed of clamping chuck drive shaft 32a into a higher rotational speed for impact generation. A first toothed wheel 74a of spur-gear transmission stage 72a is integrally formed with second coupling means 54a. In an impact drilling operation, it is driven by clamping chuck drive shaft 32a. A second toothed wheel 76a of spur-gear transmission stage 72a is integrally formed with a hammer mechanism shaft 78a. An axis of rotation of hammer mechanism shaft 78a is disposed next to the axis of rotation of clamping chuck drive shaft 32a in the radial direction. Impact-generation unit 50a has two bearings 80a, which mount hammer mechanism shaft 78a in axially fixed and rotatable manner. Impact-generation unit 50a is provided with a drive means 82a, which translates a rotary motion of impact mechanism shaft 78a into a linear motion. An eccentric element 84a of drive means 82a is integrally formed with impact mechanism shaft 78a. Using a needle roller bearing, an eccentric sleeve 86a of drive means 82a is rotationally mounted on eccentric element 84a so as to be rotatable relative to eccentric element 84a. Eccentric sleeve 86a has a recess 88a, which encloses a rocker lever 90a of impact-generation unit 50a.

Rocker lever 90a is mounted in pivotable manner on a pivot axle 92a of impact-generation unit 50a, that is to say, it is pivotable about an axis that runs perpendicularly to the axis of rotation of clamping chuck drive shaft 32a. An end of rocker lever 90a facing away from drive means 82a partially encloses a hammer means 94a of hammer mechanism 22a. The rocker lever engages with a recess 96a of hammer means 94a in the process. Recess 96a is developed in the form of a ring. When operated as impact drill, rocker lever 90a exerts a force on hammer means 94a, which accelerates the hammer means. Rocker lever 90a is moved in a sinusoidal pattern during operation. Rocker lever 90a has a flexible design. It has a spring constant between eccentric sleeve 86a and hammer 90a that is less than 100 N/mm and greater than 10 N/mm. In this exemplary embodiment, rocker lever 98a has a spring constant of approximately 30 N/mm.

Clamping chuck drive shaft 32a mounts hammer means 94a in a manner that allows it to move in strike direction 98a. To do so, hammer means 94a delimits a recess 100a. Clamping chuck drive shaft 32a penetrates hammer means 94a through recess 100a. In the process, hammer means 94a encloses recess 100a in a plane perpendicular to recess 100a to 360 degrees. When operated, hammer means 94a strikes a snap die 102a of hammer mechanism 22a. Snap die 102a is situated between an inserted tool 104a and hammer means 94a. In an operative state, inserted tool 104a is fixed in place in clamping chuck 24a. Clamping chuck 24a mounts snap die 102a so as to allow movement parallel to strike direction 98a. In an impact drilling operation, snap die 102a transmits hammer pulses originating from hammer means 94a to inserted tool 104a.

Clamping chuck drive shaft 32a is connected to snap die 102a in axially movable and torsionally fixed manner. Snap die 102a delimits a recess 106a for this purpose. When in an operative state, clamping chuck drive shaft 32a is partially situated in recess 106a of snap die 102a. Clamping chuck drive shaft 32a is rotationally mounted via snap die 102a, clamping chuck 24a, and clamping chuck bearing 70a. Clamping chuck 24a is rotationally driven via snap die 102a. For this purpose, clamping chuck 24a and snap die 102a each include coupling means 108a, 110a, which are provided to transmit the rotary motion to clamping chuck 24a. Coupling means 108a of snap die 102a is developed as groove, whose main extension is situated parallel to strike direction 98a. Coupling means 108a extends along a radially outward-lying surface area of snap die 102a. Coupling means 110a of clamping chuck 24a thus is developed as a raised region that fits the groove.

Clamping chuck 24a has an inserted-tool coupling region 112a, in which inserted tool 104a is fixed in strike direction 98a during a drilling a screw-drilling operation, or in which region it is mounted in movable manner in strike direction 98a during an impact-drilling operation. In addition, the clamping chuck has a tapered region 114a, which delimits a movement range of snap die 102a in strike direction 98a. Furthermore, clamping chuck 24a includes a mounting ring 116a, which delimits a movement range of snap die 102a counter to strike direction 98a.

During an impact drilling operation, an operator presses inserted tool 104a against a workpiece (not shown further). The operator thereby shifts inserted tool 104a, snap die 102a and clamping chuck drive shaft 32a relative to housing 12a, in a direction opposite to the strike direction 98a, i.e., in the direction of drive motor 14a. In so doing, the operator compresses spring 56a of hammer mechanism 22a. First coupling means 52a dips into second coupling means 54a, so that clamping chuck drive shaft 32a begins to drive impact-generation unit 50a. When the operator stops pressing inserted tool 104a against the workpiece, spring 56a shifts clamping chuck drive shaft 32a, snap die 102a and inserted tool 104a in strike direction 98a. This opens a torsionally fixed connection between first coupling means 52a and second coupling means 54a, so that impact-generation unit 50a is switched off.

Hammer mechanism 22a has an impact-generation deactivation unit 118a including a blocking element 120a, a sliding block guide 122a, and operating element 28a. In a drilling or screwing mode, blocking element 120a exerts a force on snap die 102a, which acts on snap die 102 parallel to at least one force of clamping chuck drive shaft 32a. The force of blocking element 120a acts on snap die 102a via clamping chuck bearing 70a, via clamping chuck 24a, and via mounting ring 116a. The force of blocking element 120a prevents an axial displacement of snap die 102a and clamping chuck drive shaft 32a during a drilling and screwing mode, and thus prevents an activation of impact-generation unit 50a. The force of clamping chuck drive shaft 32a has a functionally parallel component which drives snap die 102a in rotating fashion during operation. In addition, the force has a functionally and directionally parallel component which is brought to bear on snap die 102a by spring 56a by way of clamping chuck drive shaft 32a.

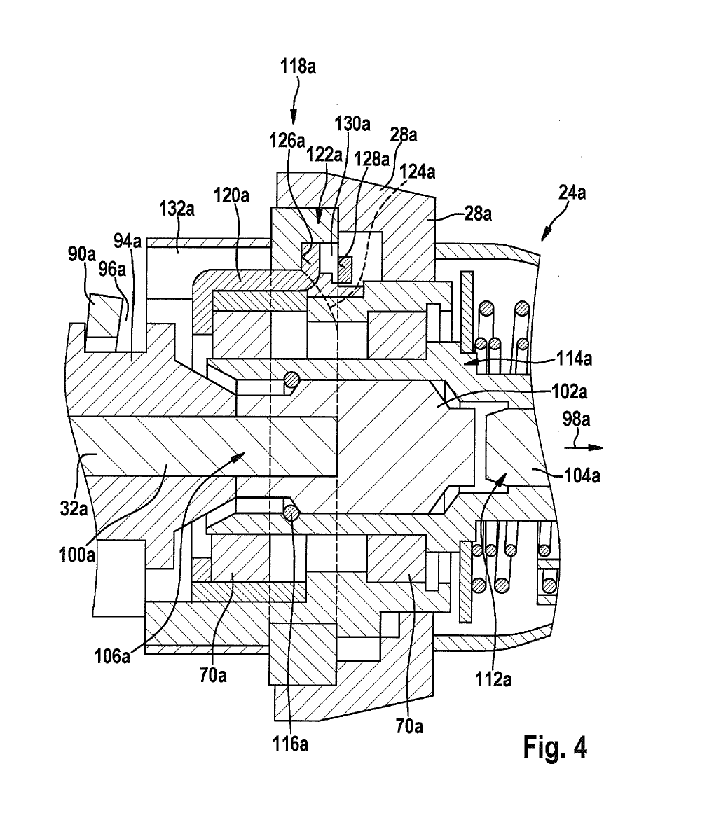

FIG. 4 shows a section that runs perpendicularly to the section of FIG. 2 and parallel to strike direction 98a, operating element 28a being disposed in two different positions in the sections of FIGS. 2 and 4. Operating element 28a is developed in the shape of a ring. It coaxially encloses the axis of rotation of clamping chuck drive shaft 32a. Operating element 28a is mounted so as to allow a rotation. It is connected to sliding block guide 122a in torsionally fixed manner. Sliding block guide 122a is likewise developed in the form of a ring. Sliding block guide 122a includes a bevel 124a. Bevel 124a joins two surfaces 126a, 128a of sliding block guide 122a. Surfaces 126a, 128a are aligned perpendicularly to strike direction 98a. Surfaces 126a, 128a are disposed on different planes in strike direction 98a.

In an impact drilling mode, blocking element 120a is situated in a recess 130a, which, for one, is delimited by bevel 124a and one of surfaces 126a. This surface 126a is situated closer to drive motor 14a than the other surface 128a. Housing 12a includes a housing element 132a, which mounts the blocking element in torsionally fixed manner and allows it to be displaced in strike direction 98a. At the beginning of an impact-drilling operation, blocking element 120a, together with clamping chuck 24a, is therefore able to be pressed in a direction counter to strike direction 98a. Blocking element 120a does not exert any blocking force on clamping chuck 24a in an impact-drilling operation. When operating element 28a of impact-generation deactivation unit 118a is rotated, blocking element 120a is moved through bevel 124a in strike direction 98a. In the drilling or screwing mode, blocking element 120a is kept in this frontal position. Blocking element 120a thereby prevents axial shifting of clamping chuck drive shaft 32a in the drilling or screwing mode.

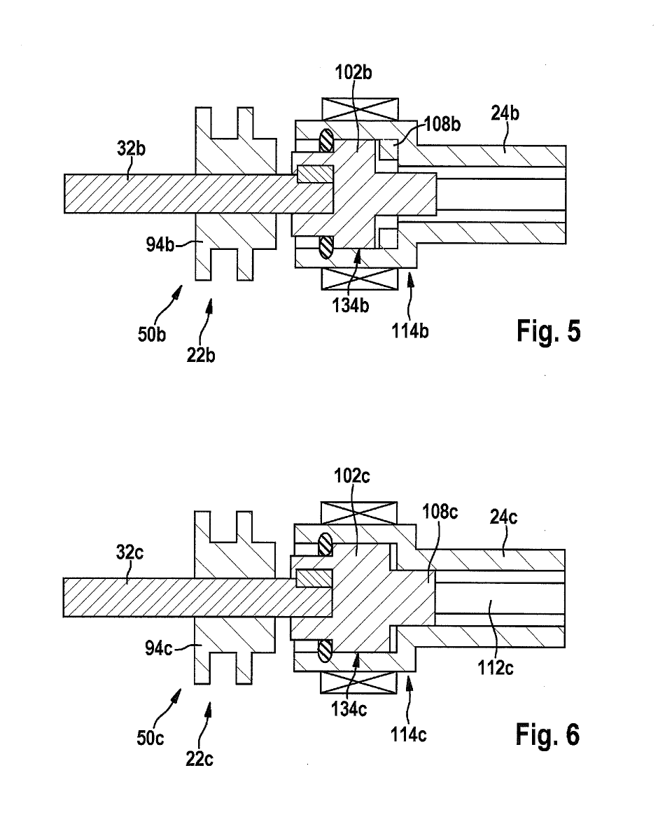

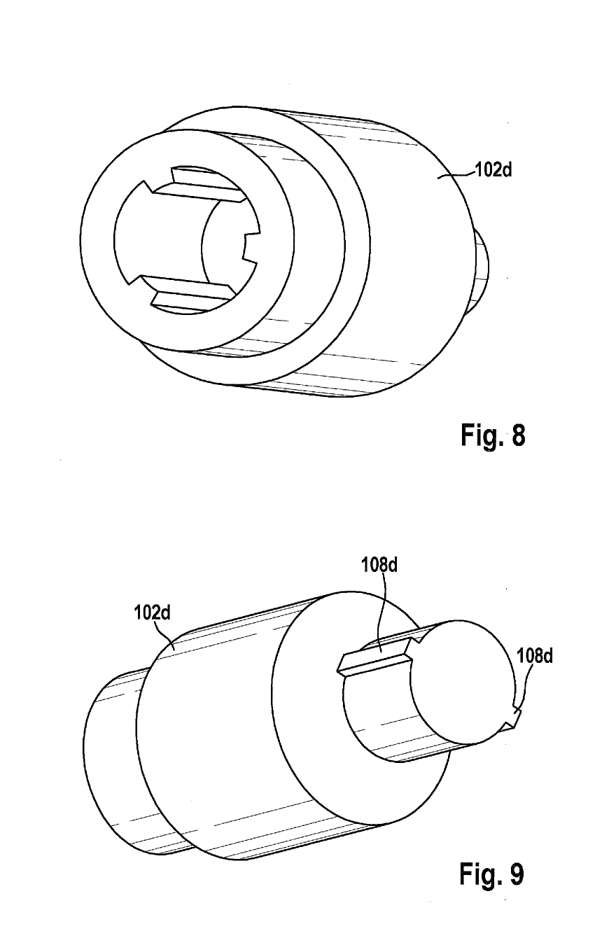

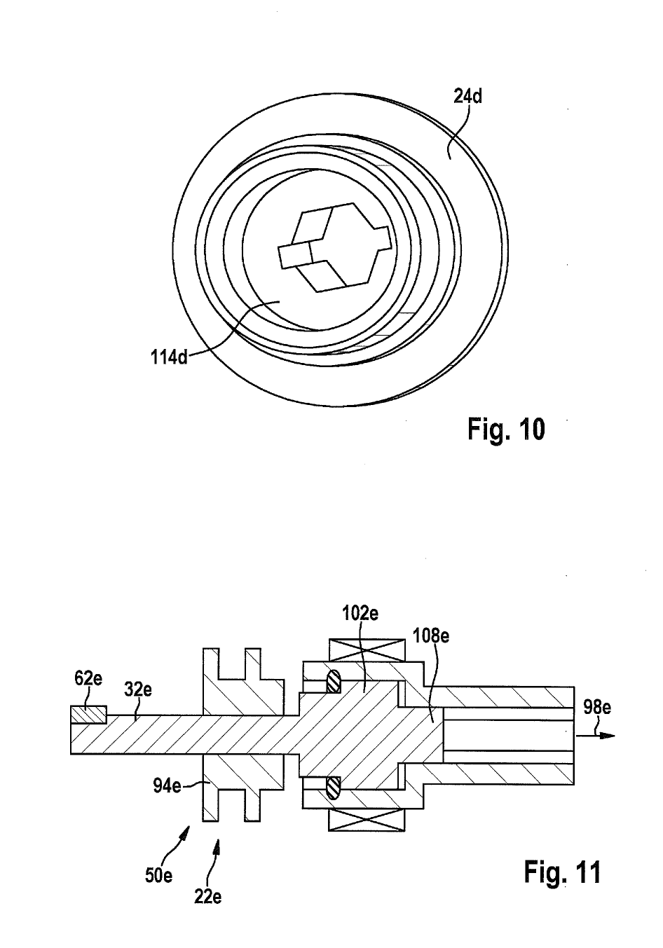

FIGS. 5 through 11 show additional exemplary embodiments of the present invention. The following descriptions and the drawing are essentially limited to the differences between the exemplary embodiments. Regarding components that are designated in the same way, particularly regarding components provided with identical reference numerals, it is basically also possible to refer to the drawing and/or the description of the other exemplary embodiments, especially of FIGS. 1 through 4. In order to distinguish the exemplary embodiments, the letter a has been added after the reference numerals of the exemplary embodiment in FIGS. 1 through 4. In the exemplary embodiments of FIGS. 5 through 11, the letter a has been replaced by the letter b or by the letters b through e.

FIG. 5 shows a portion of a hammer mechanism 22b. A hammer means 94b of an impact-generation unit 50b of hammer mechanism 22b is mounted in movable manner on a clamping chuck drive shaft 32b of hammer mechanism 22b. Clamping chuck drive shaft 32b is joined to a snap die 102b of hammer mechanism 22b in torsionally fixed and axially displaceable manner. Snap die 102b includes a coupling means 108b, which forms a torsionally fixed connection to a clamping chuck 24b of hammer mechanism 22b in at least one operating state. Coupling means 108b is situated on a side that is facing a tapered region 114b of clamping chuck 24b. Coupling means 108b is developed as teething. A sealing region 134b of the snap die is resting against clamping chuck 24b without teeth and advantageously prevents dust from entering impact-generation unit 50b.

FIG. 6, like FIG. 5, schematically illustrates a portion of hammer mechanism 22c. A hammer means 94b of an impact-generation unit 50c of hammer mechanism 22c is mounted in movable manner on a clamping chuck drive shaft 32c of hammer mechanism 22c. Clamping chuck drive shaft 32c is joined to a snap die 102b of hammer mechanism 22c in torsionally fixed and axially displaceable manner. Snap die 102c includes a coupling means 108c, which forms a torsionally fixed connection to a clamping chuck 24c of hammer mechanism 22c in at least one operating state. Clamping chuck 24c has an inserted-tool coupling region 112c, in which coupling means 108c of snap die 102c engages at least partially. Inserted-tool coupling region 112c is provided to produce forces on an inserted tool in the peripheral direction during operation. In an operative state, coupling means 108c is at least partially disposed inside a tapered region 114c of clamping chuck 24c. Coupling means 108c is developed as an external hexagon. The dimensions of external hexagon correspond to the usual dimensions of a bit for screw-fitting operations. A sealing region 134c of the snap die 102c is resting against clamping chuck 24c without teeth and advantageously prevents dust from entering impact-generation unit 50b in a manner that is able to be produced in a cost-effective way. Especially fat loss is able to be minimized.

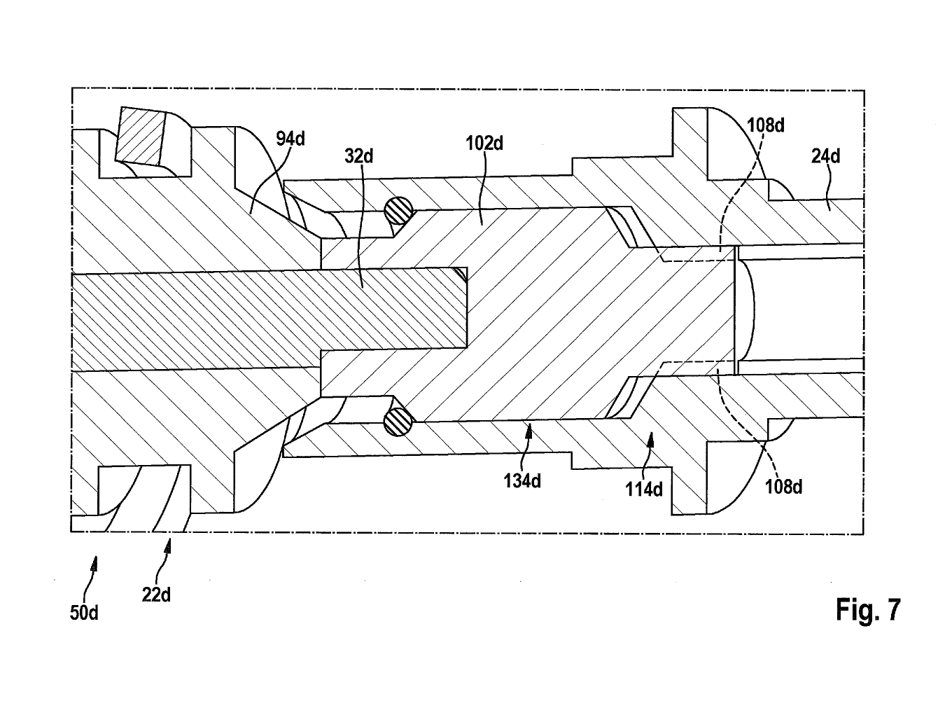

FIGS. 7 through 10 show a portion of a hammer mechanism 22d, also as a section and in a perspective view. A hammer means 94d of an impact-generation unit 50d of hammer mechanism 22d is movably mounted on a clamping chuck drive shaft 32d of hammer mechanism 22d. Clamping chuck drive shaft 32d is joined to a snap die 102d of hammer mechanism 22d in torsionally fixed and axially displaceable manner. Snap die 102d has a coupling means 108d which forms a torsionally fixed connection to a clamping chuck 24d of hammer mechanism 22d in at least one operating state. In an operative state, coupling means 108d is at least partially disposed inside a tapered region 114d of clamping chuck 24d.

Coupling means 108d is developed as teething with two coupling ribs that lie opposite each other in relation to the axis of rotation. Coupling means 108d has the same form and the same dimensions as a coupling means for coupling with an inserted tool. The form and the dimensions correspond to those of the SDS Quick standard. A sealing region 134d of snap die 102d is resting against clamping chuck 24d without teething.

FIG. 11, like FIG. 5, schematically illustrates a portion of hammer mechanism 22e. A hammer means 94e of an impact-generation unit 50e of hammer mechanism 22e is mounted in movable manner on a clamping chuck drive shaft 32e of hammer mechanism 22e. Clamping chuck drive shaft 32e is joined to a snap die 102e of hammer mechanism 22e in torsionally and axially fixed manner. Clamping chuck drive shaft 32e and snap die 102e are developed in one piece. In a strike, hammer means 94e moves both clamping chuck drive shaft 32e and snap die 102e in strike direction 98e. By way of a coupling means 62e, clamping chuck drive shaft 32e is connected in axially displaceable and torsionally fixed manner to a planetary-gear stage described in the exemplary embodiment of FIGS. 1 through 4.

1.-11. (canceled)

12. A hammer mechanism, comprising:
at least one impact-generation unit; and
a clamping chuck drive shaft, wherein the at least one impact-generation unit includes a spur-gear transmission stage adapted to translate a rotational speed of the clamping chuck drive shaft into a higher rotational speed for an impact generation.

13. The hammer mechanism as recited in claim 12, wherein:
the at least one impact-generation unit includes a hammer mechanism shaft, and
the hammer mechanism shaft includes an axis of rotation situated adjacent to the clamping chuck drive shaft in a radial direction.

14. The hammer mechanism as recited in claim 13, wherein the at least one impact-generation unit includes at least one bearing for mounting the hammer mechanism in an axially fixated manner.

15. The hammer mechanism as recited in claim 12, wherein the at least one impact-generation unit includes a hammer element mounted by the clamping chuck drive shaft in a manner allowing movement in a strike direction in at least one operating state.

16. The hammer mechanism as recited in claim 15, wherein the clamping chuck drive shaft penetrates the hammer element at least partially.

17. The hammer mechanism as recited in claim 12, further comprising:
a bearing for mounting the clamping chuck drive shaft in an axially displaceable manner

18. The hammer mechanism as recited in claim 12, further comprising:
a planetary gearing for driving the clamping chuck drive shaft in at least one operating state.

19. The hammer mechanism as recited in claim 12, further comprising:
a clamping chuck; and
a snap die including a coupling element for transmitting a rotary motion to the clamping chuck.

20. The hammer mechanism as recited in claim 15, further comprising:
a coupling element connected to the clamping chuck drive shaft in a torsionally fixed manner and for driving the at least one impact-generation unit.

21. The hammer mechanism as recited in claim 19, further comprising:
an impact-generation deactivation unit including a blocking element for acting on the snap die parallel to at least one force of the clamping chuck drive shaft in at least a drilling operation.

22. A handheld tool, comprising:
a hammer mechanism, comprising:
at least one impact-generation unit, and
a clamping chuck drive shaft, wherein the at least one impact-generation unit includes a spur-gear transmission stage adapted to translate a rotational speed of the clamping chuck drive shaft into a higher rotational speed for an impact generation.
